(19) United States
(12) Patent Application Publication
(10) Pub. No.: US 2008/0016936 A1
(43) Pub. Date: Jan. 24, 2008

(54) METHOD FOR CUTTING A TUBE SECTION INTO LENGTHS AS WELL AS TUBE SECTION

(75) Inventor: Roger Schlitter, Freiburg (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: NEOPERL GMBH, Mullheim (DE)

(21) Appl. No.: 11/775,890

(22) Filed: Jul. 11, 2007

(30) Foreign Application Priority Data
Jul. 19, 2006 (DE) 102006033409.4

(51) Int. Cl. B26F 3/00

(52) U.S. Cl. 72/367.1; 138/140; 83/676

(57) ABSTRACT

The invention relates to a method for sizing a tube section (5) of a tube (1), with the tube (1) including an inner tube (2) and an outer tube (3) covering the inner tube (2). The tube section (5) is separated with the help of a cutting tool (6) at a cutting site (8) in a cutting plane aligned perpendicular to a longitudinal extension of the tube (1). For the method according to the invention, the tube cover (3) of the tube (1) is wrapped by a tube fixation (4), for example an adhesive tape, which covers the intended cutting site, before the tube section (5) is separated from the tube (1) at the cutting site (8) with the help of a cutting tool (6). The tube fixation (4) does not only mark the intended cutting site but also counteracts a fraying of the tube cover (3) at the cutting site (8), comprising a metal and/or plastic web.

### BACKGROUND

The invention relates to a method for cutting a tube section into length from a tube, with the tube having an inner tube and an outer tube covering the inner tube, with the tube section being separated therefrom with the help of a cutting tool at a cutting site with its cutting plane being aligned perpendicularly in reference to the longitudinal extension of the tube.

The invention also comprises a tube section, particularly one made according to the method mentioned at the outset.

In the sanitary field frequently a tube section with a flexible portion is provided for an outlet faucet, a shower head, a washing machine or dishwasher or a similar consumption device. For such flexible tubes frequently hoses are used, which are provided with a water feeding inner tube and an outer tube covering the inner tube made from a metal and/or plastic web. The necessary tubes for producing such feeding tubes are regularly reeled on big drums (so-called coils) so that the provided tube section can be unreeled, measured to the respectively necessary length, and separated from the remaining tube material at a cutting site. When separating the tube section there is frequently the problem that the metal web serving as a protective tube cover is frayed to such an extent that the individual threads (so-called monofiles) of the web protrude laterally outward. Due to the fact that a tube end frayed in such a manner no longer maintains its desired shape and its defined exterior diameter the clamping sheaths necessary to fix the connector fittings can only be pushed with difficulty onto the end of the tube.

Here, some methods have already been developed in which the tube during the separation process is clamped with the help of pairs of clamping jaws and recalibrated after the separation process. After the tube, fixed with the help of clamping jaws, has been separated at the separation site the pair of clamping jaws is displaced towards the ends of the tube section and the tube web is “combed” or calibrated such that the separated tube section, at its ends, essentially retains its defined exterior diameter and largely also the original shape. During the subsequent sliding on, the clamping sheath there is still the risk, though, that individual metal or plastic fibers of the web can get caught in the interior of the clamping sheaths and that thus the web is pushed back.

### SUMMARY

Therefore the object of the invention is to provide a method of the type mentioned at the outset which essentially facilitates the production and further processing of such tube sections. Furthermore there is the object of providing a tube section of the type mentioned at the outset, which can be further processed with as little expense as possible.

The object is attained according to the invention in a method of the type mentioned at the outset such that the tube cover of the tube is coated by a tube fixation that can be cut, which preferably covers the predetermined cutting site approximately at the middle, before the tube section is separated from the tube at the cutting site via a cutting tool.

The method according to the invention provides that the tube cover, prior to the separation of the tube, is covered by a tube fixation that can be cut, which covers the predetermined cutting site. This tube fixation does not mark the predetermined cutting site but counteracts any fringing of the tube cover at the cutting site. Due to the fact that fringing of the tube cover is counteracted, and due to the fact that the cutting process therefore cannot lead to any deformation of the tube and thus to a change of the exterior diameter, the potentially necessary clamping sheath can therefore easily be slid onto the respective end of the tube in a subsequent processing step. Due to the fact that fringing of the tube cover is counteracted and that individual threads of the web cannot protrude outwards the risk of a displacement of the web is counteracted when the clamping sheath is slid on and additionally any risks for injuries caused by such protruding threads are avoided. Due to the fact that in the method according to the invention the above-mentioned pair of clamping jaws can be omitted and the method according to the invention therefore does not need any change of tools, either, the method according to the invention considerably facilitates the production of such tube sections.

For example, a heat shrinking tube can serve as the tube fixation, which is slid onto the tube up to the predetermined cutting site and is shrunk there through the application of heat before the necessary tubular section is separated from the remaining tube. A preferred embodiment according to the invention provides, however, that an adhesive tape is provided as the tube fixation, fixed on the tube cover and/or encircling the tube cover. With the help of such an adhesive tape the intended cutting site can easily be marked and this way any change of the outer tube diameter can be counteracted during the cutting process.

The tube fixation provided in the area of the cutting site on the tube cover should wrap the tube as tightly as possible and/or in a form-fitting manner. For this purpose it is possible, for example, that the adhesive tape is wrapped around the tube with its adhesive layer pointing outward such that an axial displacement of the tube fixation on the tube is hardly possible. It is particularly advantageous, however, when the adhesive tape provided as a tube fixation is fixed with its adhesive layer on the tube cover. In this way the adhesive tape serving as a tube fixation is held on the tube cover of the tube in a non-displaceable manner by its adhesive layer.

A preferred embodiment according to the invention provides that the tube is a sanitary water tube and/or the tube cover is a metal web.

It is particularly advantageous when a circular knife is provided as the cutting tool. When using a rotating circular knife the risk of the tube cover becoming frayed can additionally be reduced.

According to the invention, a tube section of the type mentioned at the outset is also provided.

### BRIEF DESCRIPTION OF THE DRAWINGS

Additional features of the invention are discernible from the following description of an exemplary embodiment according to the invention in connection with the claims as well as the drawing. The individual features can each be implemented individually or several of them combined in one embodiment according to the invention.

Shown are:

FIG. 1 is a perspective view of a tube with a web woven around it with an adhesive tape being provided in the area of the intended cutting site for sizing the tube section,

FIG. 2 is a view of the tube of FIG. 1, with the cutting site being fixed with the help of a section of an adhesive tape covering the cutting site, tightly wrapping the tube cover and holding it with its adhering layer non-displaceably on the tube cover,

FIG. 3 is a perspective view of another tube separated with the help of a rotating circular knife provided into a sized tube section and the remaining tube material,

FIG. 4 is a view of the end of the tube section secured by the adhesive tape serving as a tube fixation, with the sliding on of a pot-shaped clamping sheath onto the tube end being indicated, and

FIG. 5 a view of the tube section sized from the tube shown in FIGS. 1 through 3 with the clamping sheath slid onto its tube end.

### DETAILED DESCRIPTION OF THE PREFERRED EMBODIMENTS

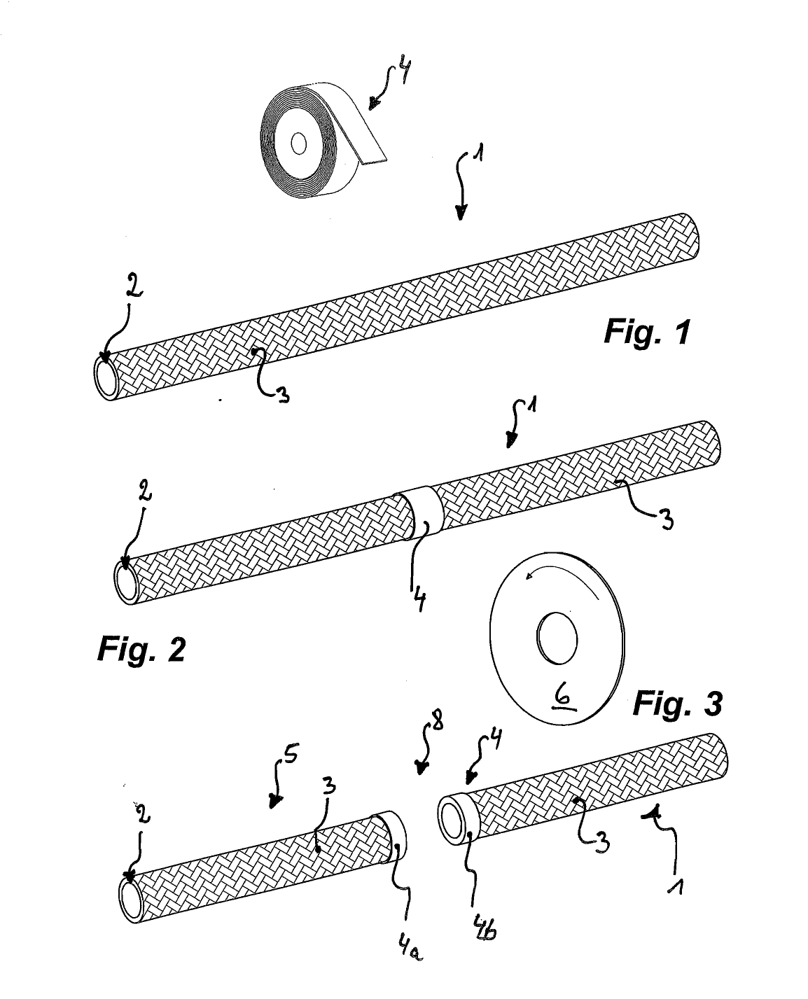

In FIG. 1 a tube is shown, which has an inner tube and an outer tube 3 wrapping the inner tube 2. In FIG. 1 it is indicated that the tube cover 3 is here embodied as a metal web, with its threads (so-called monofiles) being woven around the tube 1. The tube 1 can be stored as bulk stock on a tube drum (so-called coil), for example. From this tube stock the necessary tube sections are to be cut individually.

In order to size the tube stock a tube fixation 4 is provided, which can be cut, here embodied as an adhesive tape. This tube fixation 4 is wrapped around the tube cover 3 such that the tube fixation 4 covers the intended cutting site and tightly contacts the tube cover 3.

In FIG. 2, the adhesive tape serving as the tube fixation 4 is fixed with its adhesive layer on the tube cover 3. Here, the adhesive tape 4 is at least wrapped once entirely around the tube 1. The adhesive tape fixed on the tube according to FIG. 2 marks the intended cutting site.

In a subsequent processing step, indicated in FIG. 3, the necessary tube section 5, sized to the desired length, can be separated from the remaining tube material 1. In order to separate the tube section 5, a circular knife 6 is provided, if necessary other cutting tools may be used to cleanly cut the tube 1 as well.

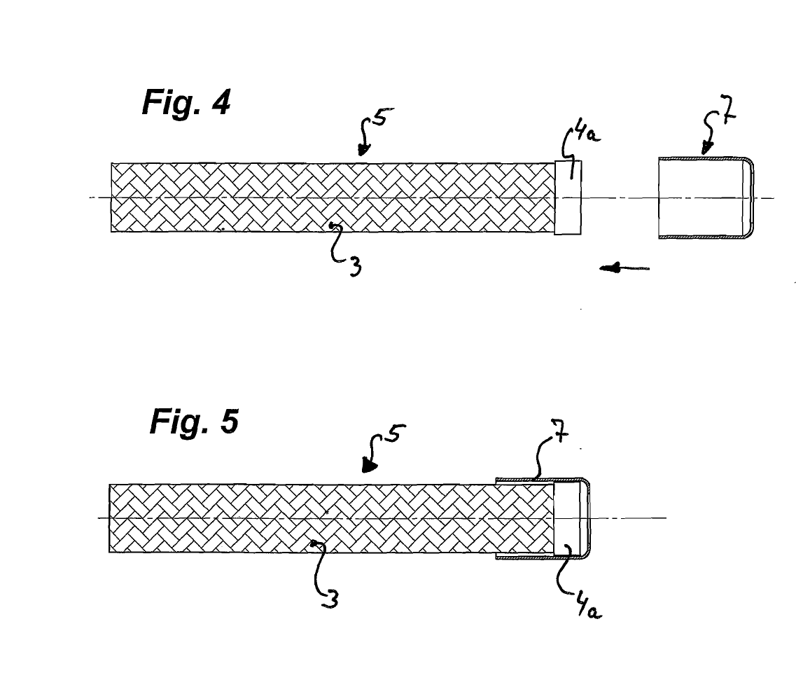

In FIG. 3 it is discernible that, after the separation, the tube ends of the tube section 5 facing each other, on the one hand, and the remaining tube material 1, on the other end, are secured via an adhesive tape section 4a, 4b. Due to the fact that the adhesive tape 4 counteracts a fraying of the tube cover 3 during the separation process and due to the fact that the preferably centrally cut adhesive tape 4 remains at the tube ends of the separated section 4a, 4b, a clamping sheath 7, shown in FIGS. 4 and 5, can be slid onto the tube section 5, remaining in true form even after the separation, with the sheath for example being necessary for fixing a connector nipple inserted into the interior space of the inner tube 2 of a connector fitting. Here, the sliding on of the clamping sheath 7 is not hindered by laterally protruding metal fibers of a frayed metal web 3. A “combing” or calibrating of the sized tube section 5 with the help of clamping jaws and a tool exchange is not necessary in the method described here.

Using the method described here a tube section can be produced, with at least at one end of the tube having an adhesive tape 4a fixed with its adhesive layer on the tube cover 4, with the adhesive tape 4a enclosing the tube cover 3.

1. A method for sizing a tube section (5) from a tube (1), the tube (1) comprising an inner tube (2) and an outer tube (3) wrapped around the inner tube (2), the method comprising:
wrapping the tube cover (3) of the tube (1) with a tube fixation (4) covering at an intended cutting site (8);
separating the tube section (5) at the cutting site (8) from the tube (1) using the cutting tool (6) in a cutting plane aligned perpendicular in reference to a longitudinal extension of the tube

2. A method according to claim 1, wherein the tube fixation comprises an adhesive tape (4) fixed on and/or wrapped around the tube cover (3).

3. A method according to claims 2, wherein the adhesive tape (4) provided as the tube fixation (4), is fixed with an adhesive layer thereof on the tube cover (3).

4. A method according to claim 1, wherein a heat shrinking tube or heat shrinking tape is provided as the tube fixation (4).

5. A method according to claim 1, wherein the tube (1) is a sanitary water hose and/or the tube cover (3) comprises at least one of a metal or a plastic web.

6. A method according to claim 1, wherein a circular knife (6) is provided as the cutting tool (6).

7. A tube section produced according to the method of claim 1, comprising an inner tube (2) and an outer tube (3) covering the inner tube (2) with at least at one tube end, an adhesive tape (4a) being fixed with an adhesive layer thereof or a heat shrinking tube being shrunk on the tube cover, the adhesive tape (4a) or the heat shrinking tube wrapping around the tube cover (3).
